(19) United States
(12) Patent Application Publication
(10) Pub. No.: US 2006/0282780 A1
(43) Pub. Date: Dec. 14, 2006

(54) Networked monitor

(75) Inventor: John William Chaney, Gilroy, CA (US)

Correspondence Address: Kenneth L. Sherman, Esq.;Myers Dawes Andras & Sherman, LLP, 11th Floor, 19900 MacArthur Blvd., Irvine, CA, 92612, US

(73) Assignee: Samsung Electronics Co., Ltd., Suwon City (KR)

(21) Appl. No.: 11/148,819

(22) Filed: Jun. 8, 2005

(51) Int. Cl. G06F 3/00

(52) U.S. Cl. 715/733

(57) ABSTRACT

The present invention provides a digital monitor that can be fully network connected, without including unnecessary components therein, similar to the way fully functional Digital Televisions (DTVs) are connected to a network.

### FIELD OF THE INVENTION

The present invention relates to networking display monitors, and in particular, to connecting digital monitors to networks.

### BACKGROUND OF THE INVENTION

A network generally includes a communication link and various devices with communication capability connected to the communication link. The devices include computers, peripheral devices, routers, storage devices, consumer electronics and appliances with processors and communication interfaces. An example of a network is a home network for a household in which various devices are interconnected. A usual household can contain several devices including personal computers and home devices such as consumer electronics and appliances that are typically found in the home. As such the term “device” generally includes logical devices or other units having functionality and an ability to exchange data, and can include not only all home devices but also general purpose computers.

Home devices include such electronic devices as security systems, theater equipment, consumer electronics such as VCRs, DVD players, stereo equipment, Television Sets and the like. Further, some home devices can include support for networking using e.g. Ethernet, 1394 standard, etc. and communication protocols such as HTTP and HTML standards for inter-device communication and operation.

In many instances, it is highly desirable to include a display device in the network which provides a display function for use by a variety of network devices to display information and possibly interact with a user. Such a network function has conventionally been reserved for digital televisions (DTVs) as networked displays for displaying information (FIG. 1). However, a disadvantage of such conventional approaches in utilizing DTVs as networked displays is that devices such as DTVs, in addition to display monitors, include additional costly components which if not used merely add cost and complexity to the network. In the case of HDTVs, such devices are required to include ATSC tuners if they contain NTSC tuners. Clearly, if the user merely wants to use the DTV for satellite or cable service decoding, then the added ATSC tuner component is unnecessary.

In one example home network (FIG. 1), a display device such as a high definition TV (HDTV) 12 is connected to a source device 14 which provides digital information to the HDTV via an IEEE-1394 network for display. The network may include a decoder 16 in a set-top box (STB) that may decode the signals from the source device 14 for the HDTV 12 as needed. However, in addition to a display monitor 13, the HDTV 12 includes other components such as tuners 15, etc. Such additional components add cost and complexity.

### BRIDF SUMMARY OF THE INVENTION

The present invention substantially addresses the disadvantages of the conventional approaches. In one embodiment, the present invention enables a digital monitor to be fully network connected, without including unnecessary components therein, similar to the way fully functional Digital Televisions (DTVs) are connected to a network.

An example network according to the present invention includes a source device, a display monitor connected to the source device via a communication link, wherein the source device provides signals to the display device, the display monitor including a display device and a controller that provides a function in the display monitor that enables the display device to properly display information represented by the signals from the source device. In one example, the controller comprises a compressed video decoder, and the display monitor does not include a tuner function.

Other embodiments, features and advantages of the present invention will be apparent from the following specification taken in conjunction with the following drawings.

### BRIEF DESCRIPTION OF THE DRAWINGS

FIG. 1 shows an example functional block diagram of a conventional network.

FIG. 2 shows an example function block diagram of an embodiment of a network according to the present invention with a display monitor.

FIG. 3 shows an example function block diagram of another embodiment of a network according to the present invention with a display monitor.

FIG. 4 shows an example function block diagram of another embodiment of a network according to the present invention with a display monitor.

### DETAILED DESCRIPTION OF THE INVENTION

In one embodiment, the present invention enables a digital monitor to be fully network connected, without including unnecessary components therein, similar to the way fully functional Digital Televisions (DTVs) are connected to a network (DTV network connections are described in CEA 2027 specification, incorporated herein by reference).

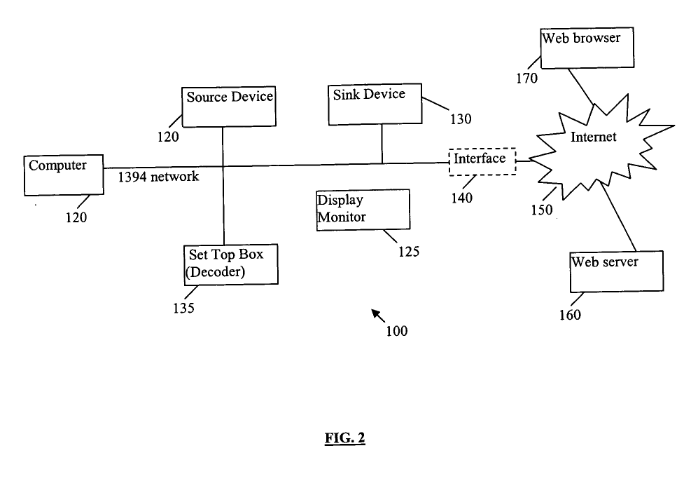

FIG. 2 shows an example functional architecture of a network 100, such as a home network, that implements an embodiment of the present invention. The network 100 comprises source devices 120, sink devices 130 (e.g., HDTV), at least one display monitor 125, and optional interface 140 that connects the network 10 to the Internet 150, the web server 160 and the web browser 170.

The network 100 may further include a decoder 135 that decodes signals from a source device 120 for a sink device 130. The devices can implement a client-server protocol, using e.g. HTTP protocol and XHTML (Extended HTML) for communication therebetween. For example, an HDTV 130 can include a Web browser and a DSS 120 can include a Web server. In one example, the sink and source devices can communicate via the TCP/IP network protocol in a 1394 network.

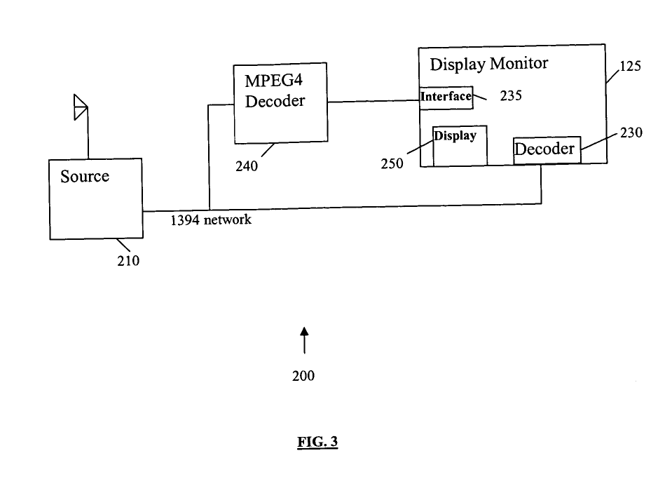

Referring to FIG. 3, another example network 200 is shown which includes a source device 210, decoder 240, and a display monitor 125, according to another embodiment of the present invention. The example display monitor 125 includes a display 250, a network connection 235 and a compressed video decoder (e.g., for MPEG2, MPEG4, WM9, etc.) function 230. The display monitor 125 does not include a NTSC/ATSC tuner function, which is not needed for digital display function.

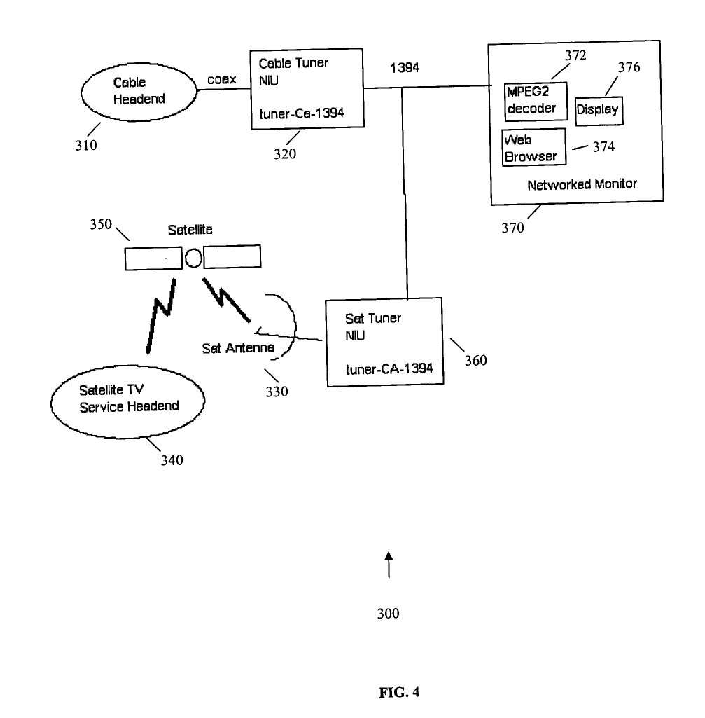

Referring to FIG. 4, another example network 300 is shown which includes a source device 310, a first tuner 320 (e.g., cable tuner NIU, tuner-CA-1394, etc.), antenna 330 for receiving signals from a satellite head end 340 via satellite 350, a second tuner 360 (e.g., satellite tuner NIU, tuner-CA-1394, etc.), and a networked monitor 370 according to another embodiment of the present invention. The example network 300 is a 1394 network. The example networked monitor 370 includes a decoder 372 (e.g., MPEG2 decoder), a Web Browser user interface 374 and a display 376. The networked monitor 370 does not include a tuner function, which is not needed for digital display function.

A display monitor according to the present invention, provides a new class of device according to the present invention. Conventional versions of display devices cannot be networked, and as noted, the network display function has conventionally been reserved for DTVs. A display monitor according to the present invention allows addition of a networked display monitor to a home network without requiring any unnecessary tuner functions.

Compared to conventional display devices, a networked display monitor 125 according to the present invention provides a different type of video input, comprising a compressed video (e.g., MPEG2) input via a network connection 235. By contrast, a conventional display device includes a fully decoded video input(s) for digital video, most usually DVI, or an analog high speed digital input such YPbPr.

The implications of such conventional configurations is that a conventional display monitor must accept fully uncompressed video, which for higher definition resolutions, requires bitrates or equivalent bandwidths in the order of 1 Gigabit per second. However, the bitrate of compressed video, used for a display monitor according to the present invention, is much less, usually at a rate of 20 Megabits per second. Further, both the compressed MPEG2 system level transport and the fully decoded DVI/HDMI signals have other requirements for uniformity of delivery rate so as to not overflow or underflow buffers.

The advantage in using a compressed video transport input in the display monitor 125 is that it is much easier to e.g. deliver a 20 Megabit per second stream wirelessly to a Plasma or LCD display monitor, than to deliver a 1 Gigabit per second uncompressed video stream. This speed difference advantage results in lower cost of a wireless channel, making acquisition and maintenance of a display monitor 125 according to the present invention more economical than conventionally possible.

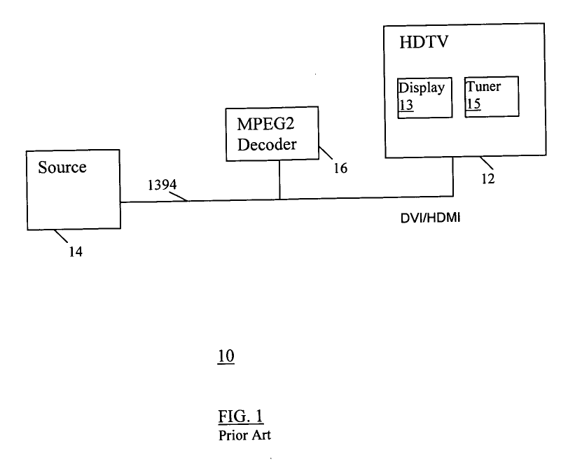

The network display monitor 125 according to the present invention has fewer components than the conventional networked DTV 12 (FIG. 1), and provides more marketable potential than a DTV 12 because the display function of the monitor 125 is optimal. Using a networked display monitor 125 according to the present invention, any required service network interface units (NIUs), may be added to the network as well as other A/V devices. All the networked devices use the single network port.

While this invention is susceptible of embodiments in many different forms, there are shown in the drawings and will herein be described in detail, preferred embodiments of the invention with the understanding that the present disclosure is to be considered as an exemplification of the principles of the invention and is not intended to limit the broad aspects of the invention to the embodiments illustrated. The aforementioned example architectures above according to the present invention, can be implemented in many ways, such as program instructions for execution by a processor, as logic circuits, as ASIC, as firmware, etc., as is known to those skilled in the art. Therefore, the present invention is not limited to the example embodiments described herein.

The present invention has been described in considerable detail with reference to certain preferred versions thereof; however, other versions are possible. Therefore, the spirit and scope of the appended claims should not be limited to the description of the preferred versions contained herein.

What is claimed is:

1. A network, comprising:
a source device;
a display monitor connected to the source device via a communication link, wherein the source device provides signals to the display device,
the display monitor including a display device and a controller that provides a function in the display monitor that enables the display device to properly display information represented by the signals from the source device.

2. The network of claim 1, wherein the controller comprises a compressed video decoder.

3. The network of claim 1, wherein the display monitor does not include a tuner function.

4. The network of claim 1, wherein the source signal comprises a compressed video signal.

5. The network of claim 1, wherein:
the source device provides encoded signals to the display monitor;
the controller decodes the source signal for the display device.

6. The network of claim 1, wherein the network comprises a 1394 network.

7. The network of claim 1, wherein display monitor includes a network input for receiving compressed video signals.

8. A display monitor, comprising:
a display device, and
a controller that provides a function in the display monitor that enables the display device to properly display information represented by the signals from the source device.

9. The display monitor of claim 8, wherein the controller comprises a compressed video decoder.

10. The display monitor of claim 8, wherein the display monitor does not include a tuner function.

11. The display monitor of claim 8, wherein the display monitor includes an input for receiving a signal that comprises a compressed video signal.

12. The display monitor of claim 8, wherein:
a source device provides encoded signals to the display monitor; and
the controller decodes the source signal for the display device.

13. The display monitor of claim 8 further including an interface for connecting the display monitor to a network.

14. The display monitor of claim 8, wherein display monitor includes a network input for receiving compressed video signals.
